(19) United States
(12) Patent Application Publication
(10) Pub. No.: US 2025/0206086 A1
(43) Pub. Date: Jun. 26, 2025

(54) TIRE CHANGER WHEEL LIFT MECHANISM

(71) Applicant: HUNTER ENGINEERING COMPANY, St. Louis, MO (US)

(72) Inventors: Alex GREENHILL, St. Charles, MO (US); Joshua DIERKING, Leslie, MO (US)

(21) Appl. No.: 18/848,470

(22) PCT Filed: Mar. 31, 2023
(86) PCT No.: PCT/US2023/017030

§ 371 Date: Sep. 18, 2024

Related U.S. Application Data
(60) Provisional application No. 63/326,243, filed on Mar. 31, 2022.

(51) Int. Cl. B60C 25/05; B60C 25/138

(52) U.S. Cl. CPC B60C 25/0521; B60C 25/138

(57) ABSTRACT

A tire changer machine having a wheel lift mechanism (100) including a lifting structure (102) adapted to rest generally flush with a floor surface in a lowered position. The wheel lift mechanism is coupled for linear movement with a wheel supporting spindle assembly (202) and driven by a linearly-actuating cylinder (112) coupled to a linkage assembly (104). Extension of the linearly-actuating cylinder operates the linkage assembly to elevate the lifting structure towards a wheel mount location on the wheel supporting spindle assembly while maintaining the lifting structure in a generally horizontal orientation.

### CROSS-REFERENCE TO RELATED APPLICATIONS

The present application is related to, and claims priority from, co-pending U.S. Provisional Patent Application Ser. No. 63/326,243 filed on Mar. 31, 2022, and which is herein incorporated by reference.

### STATEMENT REGARDING FEDERALLY SPONSORED RESEARCH

Not Applicable.

### BACKGROUND OF THE INVENTION

The present invention is related generally to tire changer machines configured to facilitate mounting and demounting of tires from wheel rims, and in particular, to a wheel assembly lift mechanism utilized to aid an operator in lifting a tire and rim wheel assembly into position for attachment to a rotationally driven spindle.

Mounting and demount a tire from a wheel rim is a common vehicle service procedure required any time a tire is replaced or repaired, and in some cases, during a routine tire rotation. The process requires forces to be exerted on the tire to pull the tire edges (beads) onto and off of the wheel rim, typically while the wheel rim is driven about an axis of revolution. To aid an operator in performing tire mounting and demounting procedures, a tire changer machine includes a rotationally driven spindle assembly onto which a wheel rim is temporarily secured, in proximity to powered tools such as bead breakers, pushers, and tire hooks utilized to manipulate the tire. During operation, either the tools are moved towards the rim secured to the spindle, or the spindle itself (and secured wheel) is linearly moved towards a tool support structure. Due to the weight of the combined tire and rim of the wheel assembly, some tire changers include wheel lift mechanisms aiding an operator in lifting and tilting the wheel assembly from the ground onto the rotationally driven spindle assembly. By necessity, a wheel lift mechanism includes a lifting portion which extends outward from a base of the tire changer machine, and onto which the wheel assembly is initially placed in an upright orientation for elevation and tilting. In a crowded automotive shop environment in which tire changer machines are often located, these lifting portions can present a trip hazard to technicians. In addition, to accommodate spindles which move linearly, the wheel lift mechanism must either include additional elements such as supports or rollers to aid in moving the wheel assembly from the lifting portion onto the spindle, or the spindle must be controlled to linearly move into position in proximity to the lifting portion each time the lift mechanism is utilized to raise or lower a wheel assembly.

Accordingly, it would be advantageous to provide a tire changer machine with an improved tire lift mechanism reducing the trip hazard to pedestrian traffic in proximity to the machine, and which consists of a simple, yet robust, design capable of linear movement with the rotationally driven spindle to maintain a fixed spacing.

### BRIEF SUMMARY OF THE INVENTION

The present invention sets forth a tire changer machine having a wheel lift mechanism including a flat lifting platform adapted to rest generally flush with a floor surface in a lowered position. The wheel lift mechanism is driven by a pneumatic cylinder coupled to a four-bar parallel motion linkage. Extension of the pneumatic cylinder operates the four-bar parallel motion linkage to elevate the lifting platform towards a wheel mount location on a driven spindle of the tire changer machine.

In a further embodiment, the wheel lift mechanism is secured to the structure of the driven spindle, so as to maintain a fixed position relative thereto during linear movement of the driven spindle towards or away a tool support structure of the tire changer machine.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of the wheel lift mechanism of the present disclosure;

FIG. 2 is an exploded perspective view of the wheel lift mechanism of FIG. 1;

FIG. 3A is a perspective close front view of a tire changer and the wheel lift mechanism of FIG. 1 in a lowered position;

FIG. 3B is the perspective view as shown in FIG. 3A, further illustrating a wheel assembly on the wheel lift mechanism;

FIG. 4A is a side view of the tire changer with the wheel lift mechanism of FIG. 1;

FIG. 4B is the side view as shown in FIG. 4A, further illustrating a wheel assembly on the wheel lift mechanism;

FIG. 5A is a side view of the tire changer with the wheel lift mechanism of FIG. 1 in a raised position;

FIG. 5B is the side view as shown in FIG. 5A, further illustrating a wheel assembly in an upright position on the elevated wheel lift mechanism;

FIG. 5C is the side view as shown in FIG. 5A, further illustrating a wheel assembly tilted from the elevated wheel lift mechanism onto the spindle;

FIG. 6A is a perspective close front view of the tire changer and wheel lift mechanism of FIG. 5A;

FIG. 6B is the perspective view as shown in FIG. 6A, further illustrating a wheel assembly in an upright position on the elevated wheel lift mechanism;

FIG. 6C is the perspective view as shown in FIG. 6A, further illustrating a wheel assembly tilted from the elevated wheel lift mechanism onto the spindle;

FIG. 7 is a side illustration of the tire changer and wheel lift mechanism of FIG. 1 secured to with a driven spindle in a retracted position; and

FIG. 8 is a side illustration of the tire changer and wheel lift mechanism of FIG. 7, with the driven spindle in an extended position.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

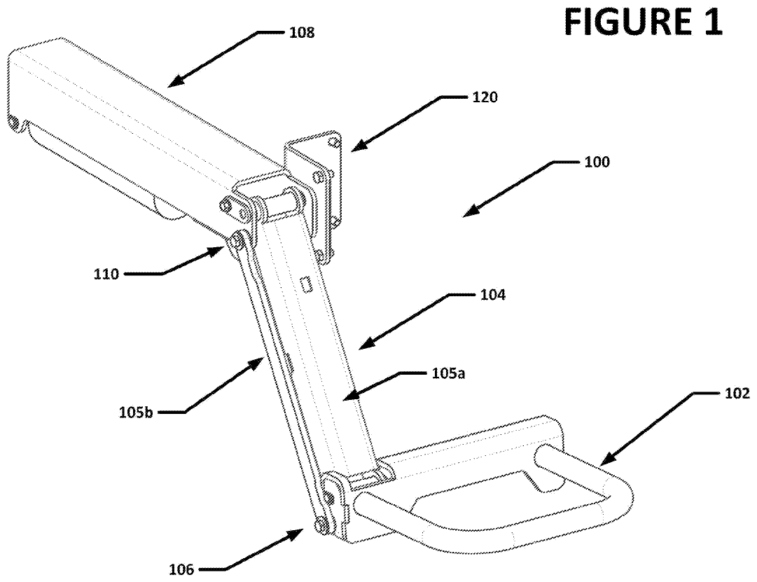

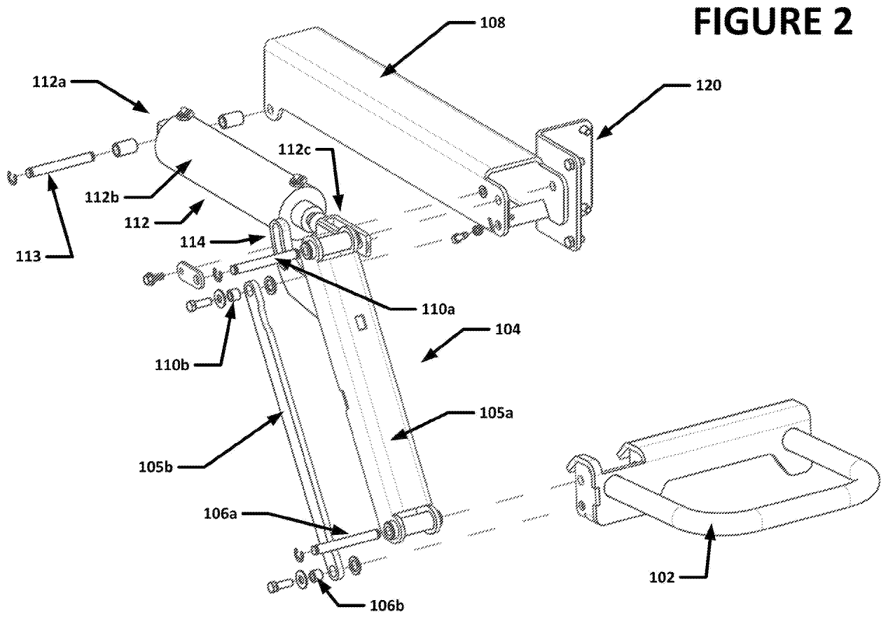

Turning to FIGS. 1 and 2, a wheel lift mechanism 100 of the present disclosure is initially shown and described in isolation from a tire changer. The wheel lift mechanism 100 includes a wheel support 102 oriented generally parallel to a floor surface on which the tire changer 10 is disposed. The wheel support platform is coupled to a linkage assembly 104 at an outer (or second) joint 106. The linkage assembly 104 consists of a main link member 105a and a secondary link member 105b, which articulate at the outer (or second) joint 106 about a first pair of parallel axes defined by a pin 106a and stub shafts 106b. The opposite ends of the main link member 105a and secondary link member 105b are coupled to a fixed support assembly 108 at an inner (or first) joint 110 and articulate about a second pair of parallel axes defined by a pin 110a and stub shafts 110b. The first and second pairs of parallel axes are parallel to each other, such that the linkage assembly 104 forms a four-bar parallel-motion linkage. The fixed support assembly 108 further supports a linearly actuating cylinder 112 secured at a base 112a of a main body 112b for rotation about a shaft 113. An actuating member 112c is configured for linear extension and retraction from within the main body 112b opposite the base 112a. An end of the actuating member 112c is coupled to an extension 114 of the main link member 105s, offset from the inner joint 110.

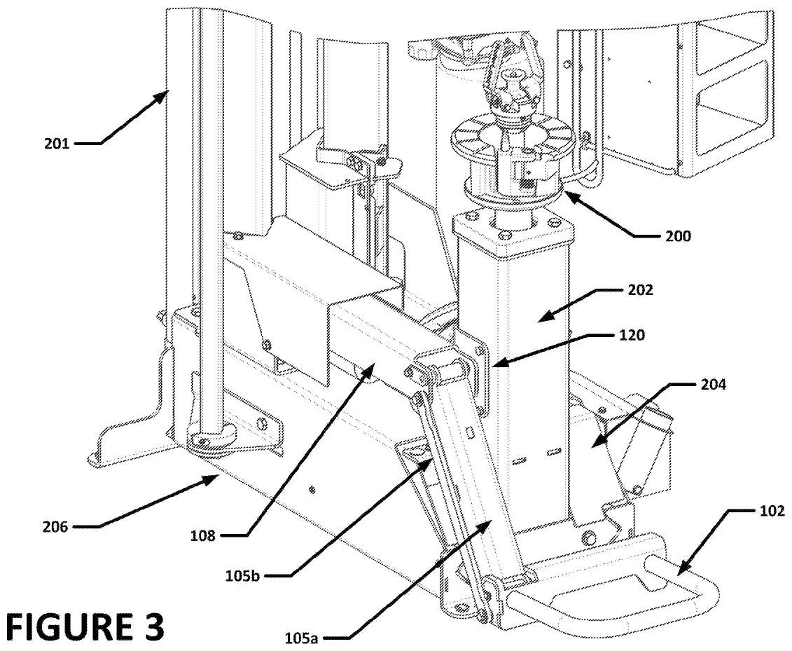

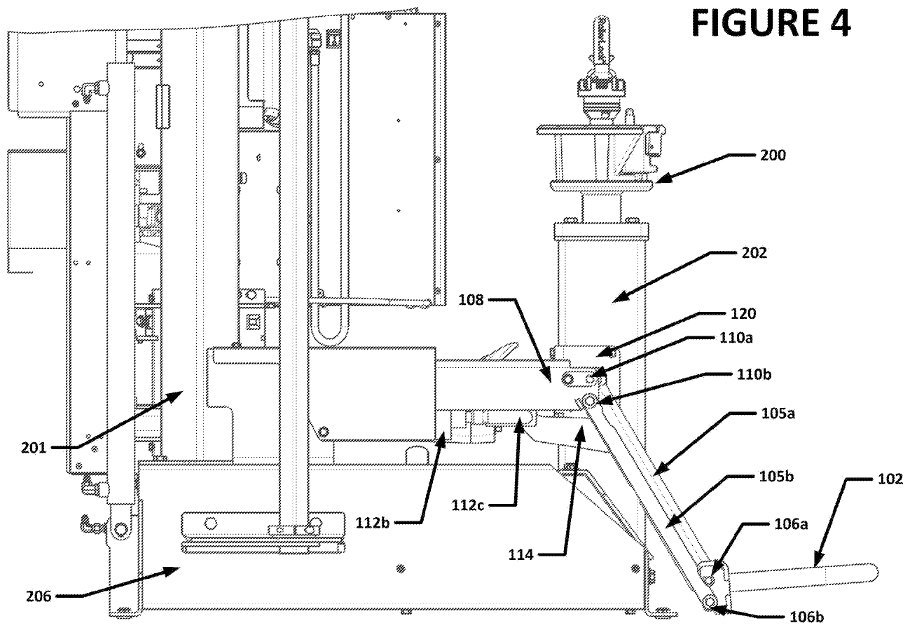

To facilitate the lifting and lowering of a wheel assembly 150 onto, and off of, the tire changer driven spindle 200, the wheel lift mechanism 100 is secured directly to the spindle housing 202 by a bracket 120 affixed to the fixed support assembly 108. As best seen in FIG. 3A and 4A, the bracket 120 is bolted to the spindle housing 202 so as to hold the fixed support assembly adjacent to one side of the spindle housing 202, parallel to a longitudinal centerline of the tire changer base 206. With the fixed support assembly 108 oriented towards the rear of the tire changer base 206, the linkage assembly 104 positions the wheel support platform in front of the spindle housing 202.

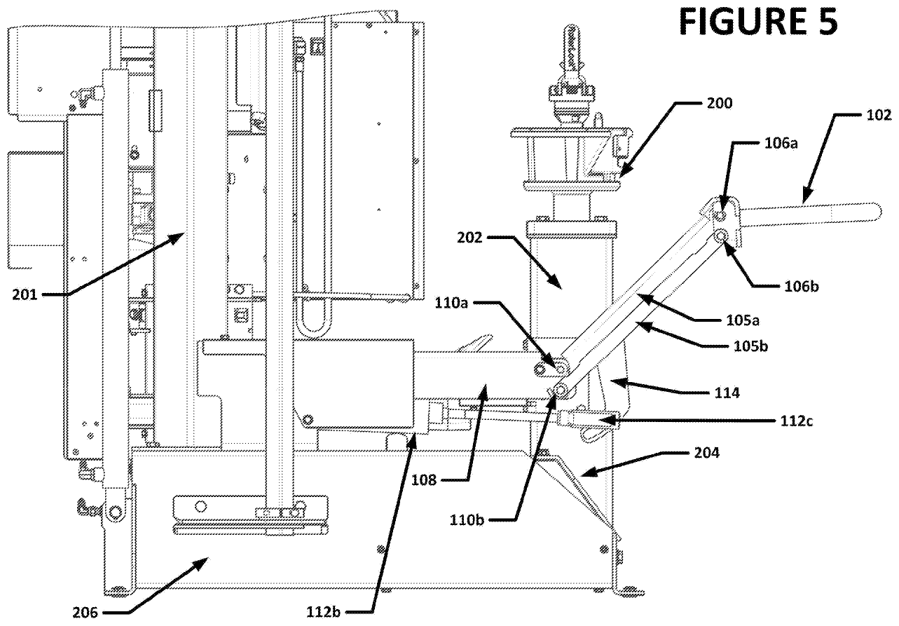

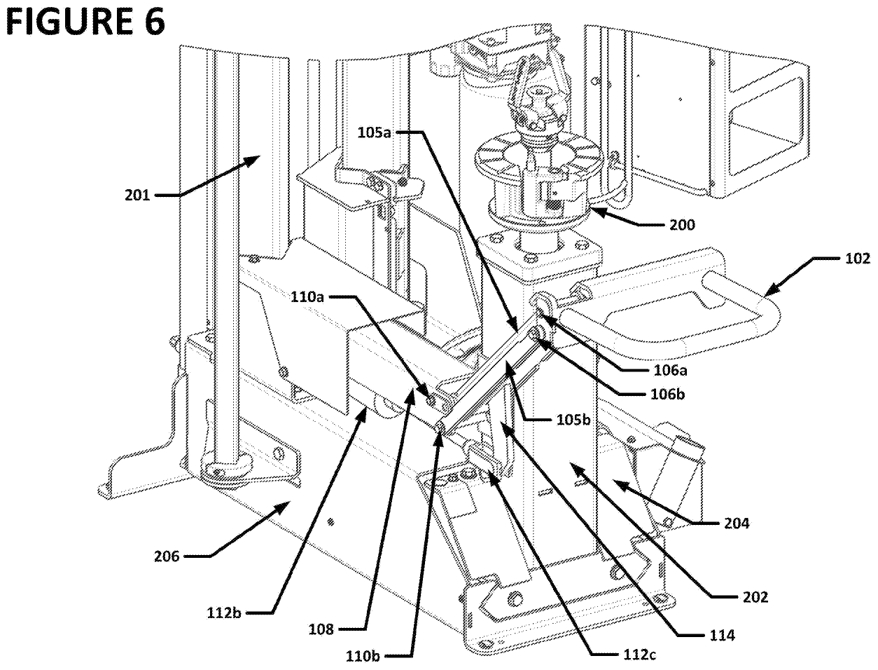

During operation of the wheel lift mechanism 100 a wheel assembly 150 is placed onto the wheel support 102, as seen in FIGS. 3B and 4B. Responsive to appropriate controls on the tire changer, an increase in a fluid pressure within the main body 112b of the linearly actuating cylinder 112 drives the actuating member 112c linearly outward, causing the extension 114 and main link member 105a to rotate about an axis of the inner joint 110. This rotation results in an elevation of the wheel support 102 upward away from the floor surface as shown in FIGS. 5A and 6A. This action elevates the wheel assembly 150 vertically towards the upper end of the spindle 200, as shown in FIGS. 5B and 6B. The same action results in the secondary link member 105b rotating about a second axis of the inner joint 110, which in turn drives a rotation of the wheel support 102 about an axis of the outer joint 106, maintaining the wheel support 102 parallel to the floor surface as the angle of the main link member 105a changes during elevation. Once the wheel support 102 reaches a maximum vertical elevation, the wheel assembly 150 is tilted or tipped over by the operator for placement onto the spindle 200, as shown in FIGS. 5C and 6C. Reducing the fluid pressure within the main body 112b of the linearly actuating cylinder 112 reverses the process, lowering the wheel support 102 (and any supported wheel assembly 150) to the floor surface. Those of ordinary skill in the art will recognize that the controlled fluid pressure within the main body 112b may be either a hydraulic fluid pressure, or a pneumatic fluid pressure without departing from the scope of the present invention. Additionally, it will be readily understood by one of ordinary skill that the fluid-pressure linearly actuating cylinder 112 may be replaced by an electrically or mechanically actuated mechanism such as a worm gear capable of controlled linear motion without departing from the scope of the present disclosure.

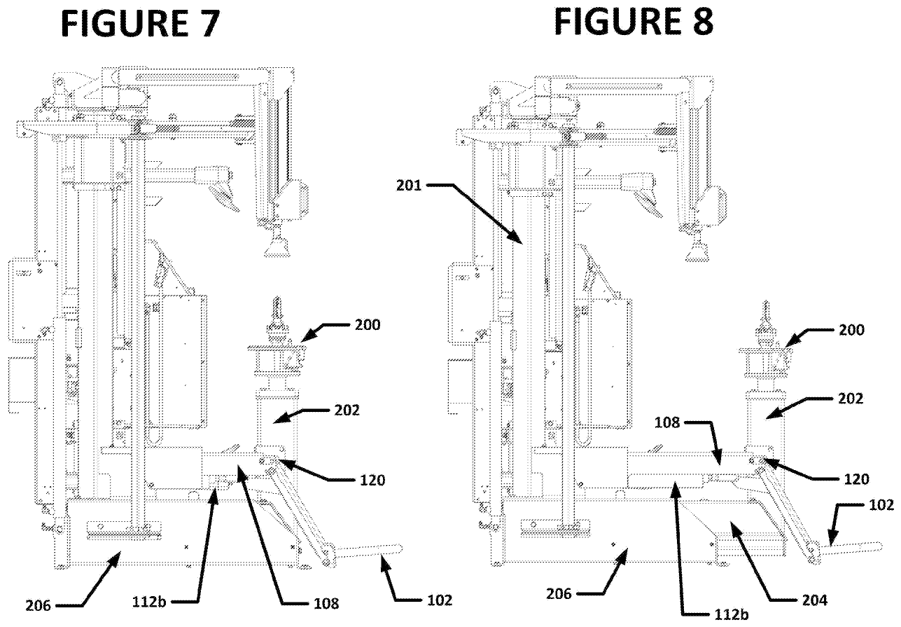

Some tire changer machines provide a mechanism for controlled movement of the spindle 200 relative to the tool support structure 201, enabling the tire changer to accommodate wheel assemblies 150 of different sizes. In a tire changer embodiment as shown in FIGS. 7 and 8, the spindle housing 202, onto which the wheel lift mechanism 100 is secured by the bracket 120, is affixed to a spindle carriage 204 supported within the tire changer base 206. The spindle carriage 204 is configured for controlled linear movement relative to the tool support structure 201, along the longitudinal centerline of the tire changer base 206. Moving the spindle carriage 204 between a fully retracted position as shown in FIG. 7, and a fully extended position as shown in FIG. 8, enables the tire changer machine to position spindle-mounted wheel assemblies having different diameters within the operating range of the various tools carried by the tool support structure 201. As the spindle carriage 204 is moved to reposition the spindle 200, the wheel lift mechanism 100 secured to the spindle housing 202 by the bracket 120 is maintained in a fixed relationship to the spindle housing 202, eliminating any need to reposition the spindle 200 prior to raising or lowering a wheel assembly on the wheel support 102.

As various changes could be made in the above constructions without departing from the scope of the disclosure, it is intended that all matter contained in the above description or shown in the accompanying drawings shall be interpreted as illustrative and not in a limiting sense.

1. A wheel lift mechanism (100) for a tire changer machine having a base (206), a tool support structure (201) mounted on the base, a plurality of tire changing tools carried by the tool support structure, and a spindle (200) having a vertical axis of rotation, and which is supported within a linearly movable spindle housing (202) carried by the base, comprising:
a support assembly (108) fixed to the spindle housing (202);
a linkage assembly (104) coupled to a forward end of said support assembly (108) by a first joint (110);
a wheel support (102) coupled to said linkage assembly (104) longitudinally opposite said first joint by a second joint (106);
a linear actuator (112) having a main body (112b) coaxially supporting an actuating member (112c) for movement along a longitudinal axis, wherein a base (112a) of said main body (112b) is coupled to said support assembly (108), and wherein an axially opposite end of said actuating member (112c) is coupled to said linkage assembly (104); and
wherein linear movement of said actuating member (112c) relative to said main body (112b) articulates said linkage assembly (104) relative to said first and second joints (110, 106), altering an elevation and relative orientation of said wheel support (102).

2. The wheel lift mechanism (100) of claim 1 wherein said spindle housing (202) is configured for linear movement relative to said base (206) to accommodate wheel assemblies of differing diameters, and wherein said support assembly (108), said linkage assembly (104), said wheel support (102), and said linearly actuating cylinder (112) move together with said spindle housing (202) during said linear movement.

3. The wheel lift mechanism (100) of claim 1 wherein altering said relative orientation of said wheel support (102) during elevation maintains said wheel support (102) parallel to ground.

4. The wheel lift mechanism (100) of claim 1 wherein said linkage assembly (104) is a four-bar parallel motion linkage.

5. The wheel lift mechanism (100) of claim 4 wherein said linkage assembly (104) includes a main link member (105a) coupled for rotation about an axis (110a) at said first joint (110) and an axis (106a) at said second joint (106), and a secondary link member (105b) coupled for rotation about a second axis (110b) at said first joint (110) and a second axis (106b) at said second joint (106).

6. The wheel lift mechanism (100) of claim 1 wherein said linear actuator (112) is either a pneumatic linearly actuating cylinder or a hydraulic linearly actuating cylinder.

7. The wheel lift mechanism (100) of claim 1 wherein fluid pressure within said main body (112b) of said linear actuator (112) is regulated by an operator control.

8. The wheel lift mechanism (100) of claim 1 wherein said wheel support (102) includes a flat plate for receiving a wheel assembly (150), said flat plate disposed on a floor surface when said wheel lift mechanism is in a lowered position.

9. A method for operating a tire changer having a base (206) supporting a spindle (200) having a vertical axis of rotation and a tool support structure (201), comprising:
positioning a wheel support (102) in a lowered position, parallel to a floor surface, adjacent a front end of said tire changer, with a longitudinal centerline of said wheel support (102) aligned with said vertical axis of rotation;
rolling a wheel assembly (150) in an upright orientation onto said wheel support (102), such that a rotational axis of said wheel assembly is longitudinally aligned with said vertical axis of rotation;
elevating said wheel support (102) to raise said wheel assembly (150) above said floor surface while maintaining said wheel support (102) in a horizontal orientation and said wheel assembly in said upright orientation;
with said wheel support (102) in an elevated position, tilting said wheel assembly in a longitudinally rearward direction (150) into a horizontal orientation supported on said spindle (200) with said rotational axis of said wheel assembly axially aligned on with said vertical axis of rotation of said spindle (200); and
lowering said wheel support (102) back to said floor surface.

10. The method of claim 9 wherein elevating said wheel support (102) includes extending a linearly actuated cylinder (112) in a horizontal direction to articulate a linkage assembly (104) coupling said wheel support (102) to a housing (202) for said spindle.

11. The method of claim 10 wherein extending said linearly actuated cylinder (112) in said horizontal direction further articulates said linkage mechanism (104) to maintain said wheel support (102) in said horizontal orientation during elevation.

12. The method of claim 9 wherein said steps of lowering said wheel support (102), tilting said wheel assembly (150), elevating said wheel support (102), and rolling said wheel assembly (150) are reversible to transfer said wheel assembly (150) from said spindle (200).

13. A tire changer machine having a base (206), a vertical tool support structure (201) mounted on the base, a plurality of tire changing tools carried by the tool support structure, a wheel lift mechanism (100), and a spindle (200) having a vertical axis of rotation, comprising:
a spindle housing (202) carried by the base, said spindle housing (202) supporting said spindle (202) for rotation about a vertical axis and configured for linear motion along said base to alter a relative position of said spindle vertical axis of rotation and said plurality of tire changing tools carried by said tool support structure;
a wheel support (102) coupled to said spindle housing (202) by a support assembly (108) and linkage assembly (104), whereby said wheel support moves linearly together with said spindle housing (202);
a linear actuator (112) coupling said support assembly (108) and said linkage assembly (104), said linear actuator (112) having a main body (112b) coaxially supporting an actuating member (112c) for movement along a longitudinal axis, wherein a base (112a) of said main body (112b) is coupled to said support assembly (108), and wherein an axially opposite end of said actuating member (112c) is coupled to said linkage assembly (104); and
wherein linear movement of said actuating member (112c) relative to said main body (112b) articulates a first joint (110) and a second joint (106) within said linkage assembly (104), altering a vertical elevation of said wheel support (102).

14. The tire changer machine of claim 13 wherein said linkage assembly (104) is further configured to alter an orientation of said wheel support (102) during articulation to maintain said wheel support (102) parallel to ground.

15. The tire changer machine of claim 13 wherein said linkage assembly (104) is a four-bar parallel motion linkage.

16. The tire changer machine of claim 15 wherein said linkage assembly (104) includes a main link member (105a) coupled for rotation about an axis (110a) at said first joint (110) and an axis (106a) at said second joint (106), and a secondary link member (105b) coupled for rotation about a second axis (110b) at said first joint (110) and a second axis (106b) at said second joint (106).

17. The tire changer machine of claim 13 wherein said linear actuator (112) is either a pneumatic linearly actuating cylinder or a hydraulic linearly actuating cylinder.

18. The tire changer machine of claim 13 wherein a motive force applied to said main body (112b) of said linear actuator (112) is regulated by an operator control.

19. The method of claim 9 further including linearly moving said tire changer spindle to synchronously alter a longitudinal position of said tire changer spindle (200) and said wheel support (102) relative to said base to position said wheel assemble supported on said spindle (200) within an operating range of at least one tool carried on said tool support structure (201).
